(19) United States
(12) Patent Application Publication
(10) Pub. No.: US 2009/0281883 A1
(43) Pub. Date: Nov. 12, 2009

(54) Flexible repeatable affiliated consumer business method

(75) Inventors: Randy J. Benson, Bountiful, UT (US); Todd R. Benson, Atlanta, GA (US); Jonathan B. Benson, Bountiful, UT (US)

Correspondence Address: Jonathan B. Benson;Randy J. Benson, 3652 South 425 West, Bountiful, UT, 84010, US

(73) Assignee: Associated Discount Clubs of America, Inc., Bountiful, UT (US)

(21) Appl. No.: 12/151,783

(22) Filed: May 10, 2008

(51) Int. Cl. G06Q 30/00; G06Q 40/00; G06Q 10/00; G06Q 20/00

(52) U.S. Cl. 705/14.3; 705/39; 705/14.43; 705/14.66; 705/14.69; 705/34

(57) ABSTRACT

The present invention is directed to a flexible affiliated consumer association business method that allows consumers to enjoy enhanced buying power with a variety of merchants while at the same time enabling merchants and other groups and institutions such as employers or associations of such consumers to establish flexible repeatable loyalty programs in a cost-efficient manner. A flexible repeatable affiliated consumer method having components which allow a provider to create customizable customer loyalty programs with greater flexibility and creativity while also being modifiable in the market environment in a manner that the program provider can design or alter the program or provide multiple tailored programs as needed to attract consumers to give custom at participating merchants. The flexible repeatable affiliated consumer method can include indicia of membership that is a debit, cash or credit card linked to an automated payment system, or any other device such as a card not linked to an automated payment system, and modes and media of communication, data flow and collection and interaction with consume members via the internet or otherwise. The flexible repeatable affiliated consumer method can include components, such as different merchants or marketing materials which are provided to allow the program provider to select different marketing characteristics with different branding characteristics and participating merchants to appeal to different consumer segments. The flexible repeatable affiliated consumer method enables linked databases for efficient program administration and a powerful consumer research mechanism that can be marketed to participating merchants by a program provider.

### BACKGROUND OF THE INVENTION

Some customer loyalty programs have been offered to the public that offer benefits to consumers and allow merchants to establish customer loyalty. However, the approaches are often limited in effectiveness. For example, such approaches may only relate to a single merchant or a limited range of products or the benefits may be very small with the result that the benefit received or perceived by the consumer may be minimal. In some cases, benefits may only be available through use of a single payment method not available to all consumers and there may be significant restrictions on how the consumer may claim benefits. In the case of some programs, there may be little or no association with a particular merchant or group of merchants in the mind of the consumer. While consumers may obtain some benefit, consumers suffer from restricted choice, lack of flexibility, inconvenience, high joining costs, lack of a sense of combined buying power, lack of affiliation and loyalty. It is often the case that purchases at a particular merchant will not be ongoing or regular. The consumer may lose or misplace a card or not value the card highly because of infrequent use, in which case the program does not result in a meaningful benefit for the consumer or results in a reduced benefit and the program does not significantly increase customer loyalty.

### BRIEF SUMMARY OF THE INVENTION

The present invention relates to loyalty programs and consumer associations. In more particular, the present invention relates to a flexible repeatable affiliated consumer method that enables consumers to benefit from enhanced buying power with a wide and varied group of merchants while enabling the establishment of effective loyalty programs by merchants and others.

The method provides members of a customer association, club or group with the variety and benefits of shopping/custom in multiple establishments with the benefits enabled by combined purchasing power and scale, consumer benefits and lower real prices. The method provides access to a wide range of participating merchants or groupings of merchants offering benefits and products and services subject to the benefit. This enables tangible benefits to participating consumers and more likelihood of regular use, which may result in a more powerful and efficient marketing tool for merchants and greater loyalty to participating merchants than is achievable through existing methods.

Variations on the method are possible, whereby specific consumer groups can be flexibly targeted for participation in an association through different marketing appeals and inclusion of participating merchants in different geographical areas. Individuals, groups, institutions, employers and organizations such as companies, charities and universities can utilize the method to provide a customized benefit to their people, participants and employees. Various associations can be linked through the method, enabling wider connectivity, extended buying power and enhanced benefits and loyalty to participants and more powerful marketing capability for merchants.

The method can be offered, licensed and franchised.

The present invention enables extension of the program to a variety of different merchants and store locations, enabling associated consumers to obtain tangible benefits on a wide range of products and services offered by participating merchants by use of a single indicia of membership. The present invention also benefits merchants by enabling targeted advertising and association with the merchant and the program in the mind of the consumer, potentially enabling enhanced loyalty. Combined benefits from a range of merchants increase the value of the membership in the mind of the consumer, suggesting the possibility of more regular use over an extended period of time. As the present method contemplates use of multiple payment methods, the present method enables a broader range of consumers to use whatever method they wish to pay for their purchases.

The present invention is directed to a flexible repeatable affiliated consumer method that allows a user to create customizable associations and loyalty programs with different appeals and benefits to consumers while also enabling merchants and other organizations to establish effective loyalty programs.

Embodiments of the flexible repeatable affiliated consumer method include several consistent features such as a program provider, participating merchants, consumers with membership in an association of some type affiliated with the program provider, indicia of membership such as a card or other device, customizable media of communication and data interchange between the program provider, members and merchants such as a website, brochures and correspondence, a membership agreement which may be varied but which in general establishes the rights and obligations of membership vis-à-vis the member, program provider and merchants, a merchant agreement which can be varied but which in general establishes the rights and obligations between the merchant, program provider and members and a defined benefit provided to members. A program provider may establish multiple affiliated consumer associations such as clubs using different marketing appeals and indicia of membership connected to a common database, which enables efficient administration and connectivity between different affiliated consumer associations and a more powerful marketing mechanism. The flexible repeatable affiliated consumer method may easily be linked with and/or implemented using existing payment systems such as debit, cash or credit cards—which may also serve as indicia of membership—or it may be implemented using “stand-alone” customized funds transfer methods if preferred by the program provider.

According to one embodiment of the present invention, the flexible repeatable affiliated consumer method includes a membership card that is also a direct debit card or cash card. The member may purchase the card or receive the card in a membership promotion. The card may be activated or later activated by the member through a web-based or other interface with a program provider that allows a member to input relevant information such as address, phone and preferred means of receiving benefits. The debit card may be used with participating merchants who agree to give a percentage of sales in the form of a cash back rebate or discount to the member and a fee to the program provider irrespective of mode of purchase (eg, cash, check, debit or credit card). Participating merchants agree to allow members to swipe the debit card at point of sale to the effect that no matter the method of purchase (ie, cash, check, credit card), the merchant transfers the discount rebate amount due to at point of sale. The member may direct that the benefit be received immediately at point of sale and [stored on their debit card] for later use with participating merchants. The member may alternatively direct that the benefit be stored by the program provider in special purpose accounts (eg, for holiday, family, charity or other special purposes) for later withdrawal upon the instructions of the member. In either case, funds and information transfer is generated at point of sale when the membership card is swiped identifying the member, merchant, purchase, price, discount and/or cash-back, which is immediately transferred to the program provider's accounts and information data base. An updatable website and other materials identify and advertise participating merchants.

In another embodiment, rather than a direct debit or cash card, indicia of membership is a credit card that also identifies the member as a member. The member may apply for the card or receive the card in a membership promotion, such as a promotion supported by merchants or credit card providers. In this embodiment, participating merchants agree to identify themselves or allow themselves to be identified as participating merchants to a credit card company or provider. Thus, when the member uses the credit card at a participating merchant, the benefit is provided at point of sale and in the case of a cash rebate discount, paid by the credit card lender on behalf of the merchant (in effect segregating the cash rebate from amounts due from the card holder). The card holder may then elect to receive an accumulated cash rebate, direct that it be applied to outstanding credit card balances, or apply for accumulating rebates to be directed to a special purpose account.

In another embodiment of the present invention, the indicia of membership is a membership card, key ring or other object not directly linked to an electronic payment system. The indicia of membership identifies the member such as through use of a code embedded on a magnetic strip or bar code or other means of identification familiar to those skilled in the art. In this embodiment, merchants agree to record member purchases and periodically send the recorded information to the program provider. If the benefit is a cash-back rebate, the merchant also calculates the amount of the rebate and remits the funds to the program provider for later remittance to members or as designated by members.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended schematic drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a program that is being created utilizing the flexible repeatable affiliated consumer method, according to one embodiment of the present invention.

FIG. 2 illustrates an alternative program utilizing the flexible repeatable affiliated consumer method which can be utilized to create an affiliated customer loyalty program linked with or implemented using a credit card having different configurations and features, according to one aspect of the present invention.

FIG. 3 illustrates an alternative embodiment of the flexible repeatable affiliated consumer method created utilizing a stand-alone payment method with participating merchants and members.

FIG. 4 illustrates interposition of a web-based interface and a database as may be appropriate in different embodiments of the present invention.

### DETAILED DESCRIPTION OF THE PREFERRED EMBODIMENTS

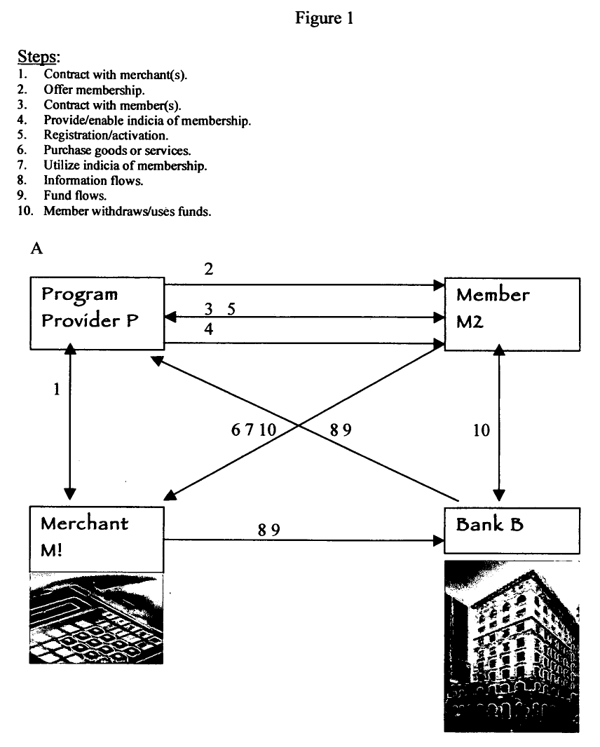

FIG. 1 illustrates a prototype customer loyalty program A, according to one embodiment of the present invention. Customer loyalty program A is constructed by a Program Provider P developing indicia of membership that is a debit card for provision 4 to Members M2. Program Provider P utilizes agreements 1 2 3 with Merchants M1 and Members M2, which set out the rights and obligations of Merchants M1 and Members M2, including provision of a cash-back benefit payable 9 10 to Members M2 upon a Member's M2 activation of its membership account and giving of custom 6 to a Merchant M1, selection 6 of an item for purchase and presentation 7 and swiping of a Member's M2 indicia of membership that is a debit card at point of sale. Presentation 7 and swiping of Member's M2 debit card at point of sale 7 results in automatic transmission of data 8 and funds 9 to database and accounts of Program Provider P and Bank B.

Program Provider P may enter 1 into a relationship with Merchants M1 who will participate in Program A. The relationship may be contractual, by license, formal or informal. Terms of the relationship may define the nature of the benefit to be provided by Merchants M1 to Members M2, manner of implementation of Program A, including without limitation mode of recognizing membership of Members M1, recording and transferring sales and transaction data from individual sales transactions between Merchant M1 and Members M2 at point of sale, the mode of conferring the contracted benefit to Members M2 and Program Provider P's fee to Program Provider and such other terms deemed appropriate for implementation of the Program A and to establish the rights and obligations of Program Provider P, Merchant M1 and Members M2 and third parties. Contracts may contain a variety of other terms or variations on terms, which may be fixed for implementation by Merchants M1 or variable according to negotiation between Program Provider P and Merchants M1 depending for example on the relative bargaining power of the parties, the need to customize Program A to accommodate the needs of Merchants M1 or preferences of Program Provider 1 in creation of a flexible repeatable customer loyalty program.

In the present embodiment, forms of relationship instruments, such as contracts may be delivered by Program Provider P to Merchants M1 for negotiation or immediate execution such as a shrink-wrap or click-this contract and implementation by means of a salesperson trained to explain the benefits of Program A to Merchants M1. For example, contracts may be delivered and negotiated in any manner or format deemed appropriate, including without limitation by Internet or mail.

Program Provider P may offer 2 memberships and enter 3 into relationships with Members M2 who wish to associate themselves with and participate in Program A. Such relationship instruments such as contracts may contain terms relating to the nature of the benefit to be provided by Merchants M1 to Members M2, manner of implementation of Program A, including without limitation mode of recognizing membership of Members M1, indicia of membership and mode of recognizing Members M1 at time of purchase, the mode of conferring the contracted benefit to Members M2 and such other terms deemed appropriate to implement the Program A and to establish the rights and obligations of Program Provider P and Members M2 and third parties. Relationship instruments may contain a variety of other terms or variations on terms according to preferences of Program Provider 1 in creation of flexible repeatable customer loyalty programs.

In the present embodiment, forms of contracts may be delivered by Program Provider P to Merchants M1 for delivery to members M2 or by means of a salesperson trained to explain the benefits of Program A to Members M2. However, contracts may be delivered and negotiated in any manner or format deemed appropriate, including Without limitation by internet or mail.

In this embodiment of the present invention, Program Provider P provides 4 Member M1 with indicia of membership that is a card. The card may be provided 4 directly to Member M1 by Program Provider P, by Merchant M1 on behalf of Program Provider P at the Merchant's establishment or by any other means familiar to one skilled in the art, including without limitation a salesperson that signs up the Member M1. The card, which may be designed in any manner with any combination of colors, words and designs, may be impressed with the Member M1's name or other manner of identification, such as a code embossed on the face of the card or contained in bar code, magnetic strip or other means. In the present embodiment, cards offered on behalf of Program Provider P by Merchants M1 will not initially be impressed with Member M2's name but may be replaced at the election of Member M2 either on a website interface with Program Provider P or through registration materials provided to Member M2. As will be appreciated by one skilled in the art, indicia of membership can be any device, or number of devices, that enables a Merchant M1 to identify the holder of the device as or connected with a Member M1.

Program Provider P may develop different means of promoting Program A and communicating with Merchants M1 and Members M2. In the present embodiment, such mode of promotion and communication may include a website, printed material such as brochures explaining the benefits of Program A to Members M2 and advertising materials that will be placed in Merchant M1 establishments and other locations and media. These modes of communication will be designed to establish an interface between Program Provider P and Members M2 in a manner that encourages continued and regular use of the indicia of membership at points of sale at Merchant M1 establishments and repeated reference to the modes of communication to entice a Member M2 to provide its custom to participating Merchants M1 advertising on the website. For example, the website will contain information and banner information on participating Merchants M1 where Members M2 can utilize 7 their indicia of membership. Regular and repeated exposure to modes of communication and use of the indicia of membership positioned to secure the attention of Members M2 will reinforce behavior of Members M2 in such a manner that Members M2 will be encouraged to direct their custom to participating Merchants M1 and make purchases in a more targeted manner.

In the illustrated embodiment, Program A contemplates a cash-back on Member M2 purchases at Merchant M1 establishments. A variety of other additional components can be provided in connection with Program A. For example, the illustrated embodiment contemplates the ability for Members M1 to direct how they wish to receive their cash-back benefits, including without limitation receiving cash or directing the cash to special purpose accounts (for example family vacations, college savings, charity) kept on Member M2's behalf by or on behalf of the Program Provider P to enable savings for vacations, college or charity, for example. Members M2 may be able to access an account on Program Provider P's website and give directions from such account relative to their accumulating benefits. Additional benefits can also be provided relative to other components of Program A, including discounts and special offers to entice Members M2 to direct their custom to particular Merchants M1. The benefits provided by Merchants M1 and Program Provider P result in positive feedback to Members M2 in buying decisions. The sense of a constantly recurring benefits to Members M2 further strengthen Member M2's desire and eventual habitual use of the indicia of membership at participating Merchants M1 and Member M2's connection with and loyalty to participating Merchants M1.

In this embodiment of the present invention, Member M2 may activate 5 the indicia of membership by accessing Program Provider P's website or by sending registration materials to Program Provider P. At time or registration, Member M2 may provide details about such member, including Member M2's contact details such as phone and address and financial details to enable future disbursement of funds to Member M2. In situations where an already-activated generic card may be sold or provided to Member M2 by or at a participating Merchant M1 to enable immediate purchases 6 subject to the benefit, Member M2 may still need to register 5 with Program Provider P to fully enable Member M2's membership.

In order to avail of the benefits of Program A, Member M2 gives custom 6 to Merchant M1 and selects 6 items or services for purchase. At point of sale, Member M2 utilizes 7 the indicia of membership to identify itself as a Member M2 to avail itself of the benefits of Program A, irrespective of the method of payment. For example, Member M2 may pay for its purchases using cash, check or a credit card.

In one embodiment of the present invention, represented by FIG. 1, the indicia of membership is a direct debit card that is swiped 7 by Merchant M1 at point of sale. Information regarding the sale is automatically sent 8 to Program Provider P's database, immediately or batched with information regarding other sales. As represented in FIG. 1, sale information might include identification numbers for Merchant M1 and Members M2, sales price and information on the items or services purchased. Cash back benefit funds and fees due to Program Provider P are automatically transferred 9, immediately or batched with other fund transfers, from Merchant M1 to Program Provider P and Member M2 or to accounts of Member M2 maintained by or on behalf of Program Provider P. Alternatively, such funds could be added to the debit card of Member M2 for immediate or later use. As cash-back funds accumulate, Member M2 can elect to let them build or they may withdraw 10 from cash balances that have accumulated in their sub-account maintained by or on behalf of Program Provider P. Alternatively, Member may elect to use accumulated cash-back funds to fund purchases from Merchant M1.

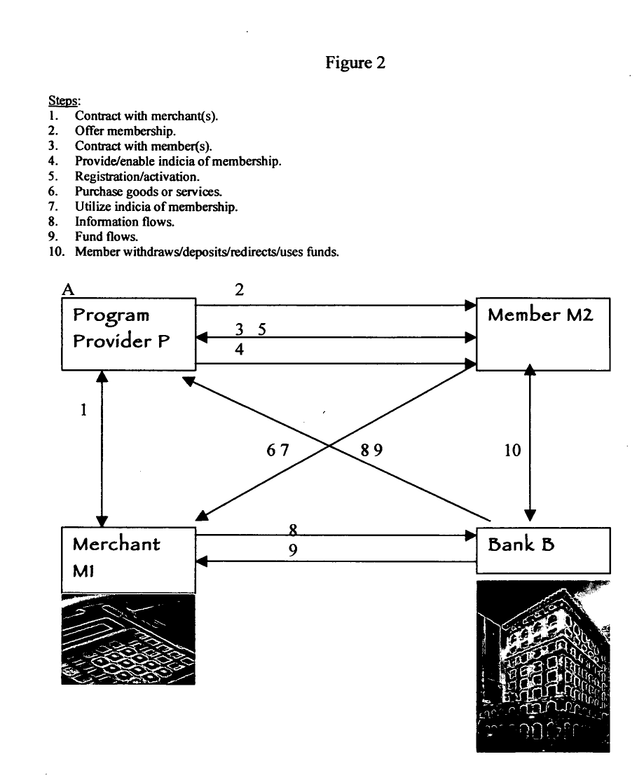

In another embodiment of the present invention, represented by FIG. 2, the indicia of membership is a credit card that is swiped 7 by Merchant M1 at point of sale. Information regarding the sale is automatically sent 8 to Program Provider P's database, immediately or batched with information regarding other sales. As represented in FIG. 2, sale information might include identification numbers for Merchant M1 and Members M2, sales price and information on the items or services purchased. In addition to funds due to Merchant M1, cash back benefit funds and fees due to Program Provider P are automatically transferred 9, immediately or batched with other fund transfers, from credit card provider to Program Provider P and Member M2 or to accounts of Member M2 maintained by or on behalf of Program Provider P. As cash-back funds accumulate, Member M2 may elect to let such funds build or they may withdraw 10 from cash balances that have accumulated on their credit card or they may direct that such funds be deposited in a sub-account maintained by or on behalf of Program Provider P. Alternatively, Member may elect to use accumulated cash-back funds to fund purchases from Merchant M1.

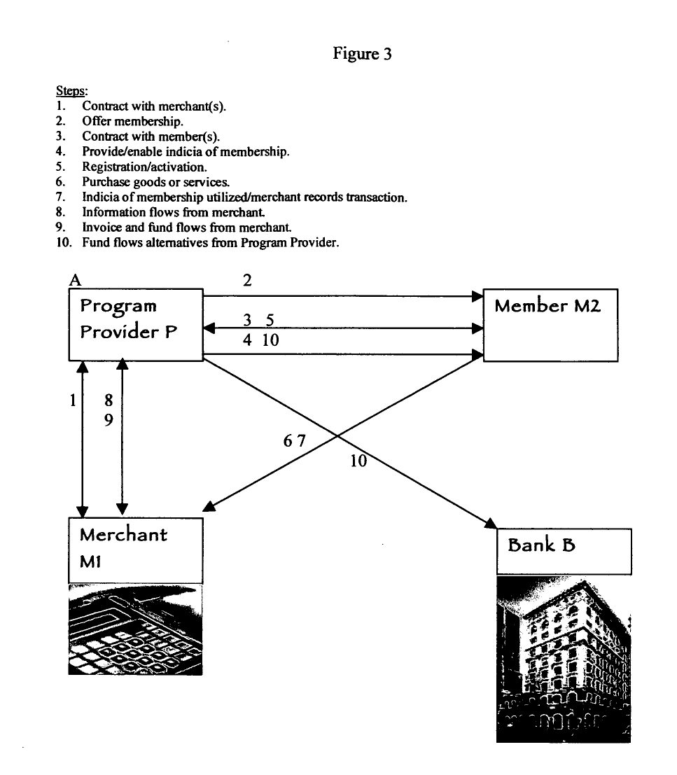

In another embodiment of the present invention, represented by FIG. 3, the indicia of membership is a card not directly linked to a payment system that is presented 7 by Member M2 at point of sale. Information regarding the sale is recorded 7 by Merchant M1 and sent 8 by Merchant M1 to Program Provider P. As represented in FIG. 3, sale information might include identification numbers for Merchant M1 and Members M2, sales price and information on the items or services purchased. Program Provider P issues 9 an invoice to Merchant M1 for funds due, following receipt of which Merchant M1 sends funds due. Alternatively, cash back benefit funds due to Members M1 and fees due to Program Provider P may be automatically transferred by Merchant M1 to or for Program Provider P 9, immediately or batched with other fund transfers. Following receipt of cash back funds from Merchant M1, Program Provider P sends funds to which Members M2 are entitled to Members M2 or deposits such funds as directed by Members M2.

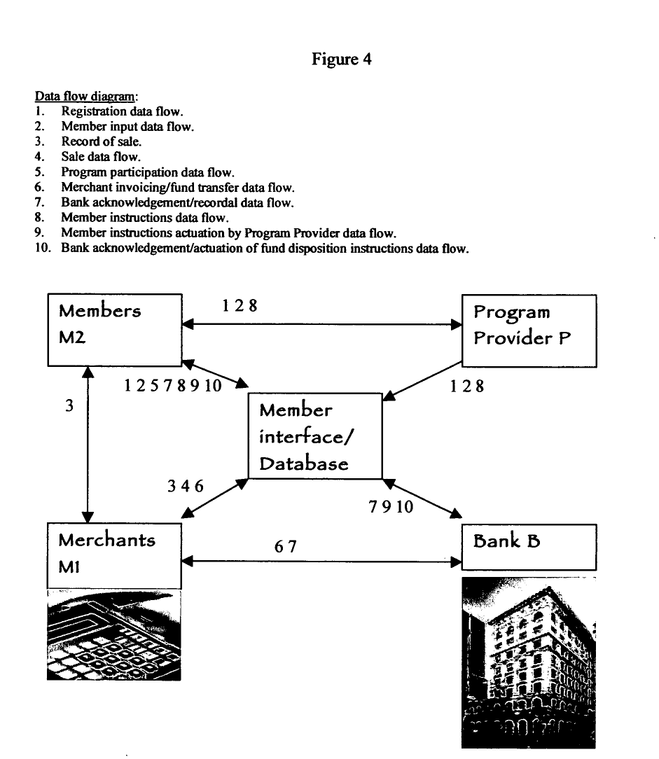

FIG. 4 is a data flow diagram describing how Program Provider P may utilize software, an internet interface and a database to implement the present invention. In the present embodiment, data is generated when Members M2 apply to participate in Program A and/or register 1 with a Program Provider P. This may be accomplished via a member interface website linked to a database or via printed application materials provided by Program Provider P to Member M2. Member M2 data is input 2 by Program Provider P or by Member M2 on Program Provider's member interface website and recorded on Program Provider P's database; Program Provider P acknowledges Member M2 registration, provides 2 Member M2 with membership information such as a pin number or access code to access Member M2's account on Program Provider P's website.

Alternatively, Program Provider P may provide Members M2 with pre-activated indicia of membership that can be obtained directly from Program Provider P or from Merchants M1 for immediate use with benefits that can be claimed upon Member M2's registration 1 with Program Provider P.

Data is additionally generated when a Member M2 gives custom 3 to a participating Merchant M1 by purchasing goods or services and Merchant M1 records the sale and provides 3 a sales receipt to Member M2. In one embodiment of the present invention, Merchant M1 swipes Member M2's indicia of membership in card reader connected to a system proprietary to Program Provider P that enables immediate transfer of sales data to Program Provider P's database. In another embodiment, Merchant M1 records 3 sales to Members M1 in its own database and sends 4 data on such sales to Program Provider P by means of a computer diskette or tape. As will be appreciated by one skilled in the art, there are many different means whereby data may be transferred 4 from Merchants M1 to Program Provider P.

In the present embodiment, the benefit provided to Members M2 is a cash-back benefit. Through use of software linking Program Provider P's database with its member interface, Program Provider P provides 5 information on accumulating sales and benefits to Members M2 through its member interface. Members M2 access 5 such data by accessing their Member M2 accounts on Program Provider P's member interface. Through use of software linked to its database, Program Provider P generates 6 an invoice for Members M2 cash-back benefits and Program Provider P fees due from participating Merchants M1 and sends 6 such invoice to participating Merchants M1. Alternatively, Merchants M1 may automatically or periodically transfer 6 such funds to Program Provider P's Bank B. In any case, once Bank B receives funds from Merchants M1, Bank B may acknowledge 7 receipt to Merchant M1 and to Program Provider database, whereupon through use of software, Program Provider P reflects receipt of such funds in respect of each relevant Member M2 that is entitled to such funds due to its presentation of indicia of membership at time of purchase at such participating Merchant M1. This data is recorded in Program Provider P's database where it may be accessed through use of software linked to Program Provider P's member interface, enabling Members M2 to track accumulation of benefits due to them.

Additional data flow transpires when Members M2 initiate instructions 8 on disposition of accumulated member benefit funds to Program Provider P or via Program Provider P's member interface. For example, Members M2 may claim such funds in whole or in part or they may direct them to be deposited in special purpose accounts maintained by or on behalf of Program Provider P in Bank B. Through use of software, Program Provider P records Member M2 instructions regarding disposition of member benefit funds in Program Provider P's database and provides 9 Member M2 instructions to Bank B. Bank B acknowledges 10 receipt of such instructions, acts on such instructions and may report such information back to Program Provider P. Such information is recorded in Program Provider P's database, where it may be accessed by Members M2 through use of software linked to Program Provider P's member interface.

In alternative embodiments of the present invention, dataflows could be oriented more closely around an interface and/or databank maintained by a bank or other financial institution, such as a bank or financial institution enabling use of indicia of membership that is a debit, cash or credit card. In such embodiments, the member interface and database depicted in FIG. 4 could be replaced or augmented by an interface and database supplied by Bank B and dataflows structured accordingly. For example, Item 4 in Data Flow Diagram 4 would involve dataflow to Bank B. Members M2 could give instructions 8 on disposition of funds directly to Bank B and Bank B could directly acknowledge to Members M2 on a member interface maintained by Bank B, recording all related actions in a database maintained by Bank B.

As will be appreciated by those skilled in the art, the size, configuration, and juxtaposition of elements utilized with the invention and customizable programs can vary without departing from the spirit and scope of the present invention. For example, in various embodiments of the present invention, program participants may have overlapping or combined responsibilities. For example, Program Provider could be a financial institution or other services provider such as Bank B or information technology provider, enabling significant program synergies. Additionally, the size and configuration and known elements not depicted (eg, invoicing systems and the like), can be utilized without departing from the spirit and scope of the present invention.

In any embodiment of the present invention, targeted appeals with different advertising approaches and features (eg, linked special purpose accounts) and access points (eg, separate clubs/associations with different marketing concepts) can minimize the possibility that interaction will not appeal to a particular class or group of individuals.

Use of the program by the consumer member, including wielding the indicia of membership at time of purchase at participating members, review of accumulating website data at program provider's member interface and customization of the program by the member (eg, establishment of special purpose “savings accounts”), minimizes the potential that the consumer member might stop using the program. Positive feedback enabled through use of advertising, email correspondence on increasing fund balances and positive interaction with program provider and merchants reinforce continued and regular use of the program.

As previously discussed, Program A is configured to be customizable by the Program Provider. As will be appreciated by those skilled in the art, a variety of types and configurations, and a number of different components can be utilized in connection with the program without departing from the scope and spirit of the present invention. For example, programs can be created from a variety of different merchants and marketing approaches to appeal to different categories of consumers. As a result, a Program Provider may use creativity and different strategies in creating programs. For example, a variety of different features and benefits may be provided. Advertising appeals may be delivered that add excitement and appeal to programs. At the same time, linking different consumer associations to a common database that captures sales and other data can be used to maximize program provider and merchant understanding of how different marketing appeals attract different consumer categories.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product for managing a customizable flexible repeatable affiliated consumer method that allows a program provider to create customizable flexible customer loyalty programs with greater flexibility and creativity while also being modifiable in the market environment allowing the provider to design programs as needed to appeal to different consumer segments and merchants, the method including:
identifying an agreed to term pursuant to a merchant relationship;
identifying an agreed to term pursuant to a member relationship;
computing a defined benefit such as cash-back utilizing the agreed to term pursuant to the merchant relationship and the member relationship;
providing information regarding the benefit by means of an interactive website;
providing the defined benefit by means of a payment system to enable payment of benefits to consumer members.

2. A computer program product as claimed in claim 1, further comprising;
electronic system, software and a database connecting merchants and the program provider to enable tracking of card use, calculation and payment of the benefit;
enabling customizable features such as special purpose accounts where cash benefits may accumulate, and a base for securing additional components of a program;

3. A user interface for providing a customizable flexible repeatable affiliated consumer method that allows a program provider to create customizable loyalty programs with greater flexibility and creativity while also being modifiable in the market environment allowing the provider to design programs as needed to appeal to different consumer segments and merchants, the method comprising:
identifying one or more customer loyalty programs that merchants can subscribe to with reach beyond their own store-based or dedicated programs;
providing a mode of efficient targeted advertising that can supplement or replace merchant marketing programs;
transferring cost to the merchant only as members purchase goods or services from the merchant;
identifying modes of related targeted advertising that merchants can subscribe to for example on a program provider website accessed by members, placement of merchant logos on program materials and indicia of membership provided to members, notices of special sales and offers;

4. A user interface for providing a customizable flexible repeatable affiliated consumer method as claimed in claim 3, further comprising;
indicia of membership members may use at many different participating merchants, making continued use of the indicia of membership more likely;
member access to special benefits at participating merchants available to members irrespective of or by reference to product or merchant types, including retail and wholesale merchants, ensuring that reach of the program is not limited to the four walls or one or a few merchants;

5. A customizable flexible repeatable affiliated consumer method that allows a program provider to create customizable loyalty programs with greater flexibility and creativity while also being modifiable in the market environment allowing the provider to design programs as needed to appeal to different consumer segments and merchants and/or enabling the program provider to establish multiple modular consumer associations consisting of common, some common, or completely different participating merchants, marketing appeals and benefits utilizing customized marketing materials designed to appeal to different consumer segments and allowing the program provider to offer multiple additional linked or delinked consumer loyalty programs, comprising;
one or more consumer media communication components designed to allow a program provider to select different appeals associated with one or more consumer segments;
one or more website interfaces designed to enable a program provider and participating merchants to select different appeals associated with one or more consumer segments;
a common database supporting various consumer associations, enabling a program provider to efficiently support multiple consumer associations, lowering costs of administration;
a common database supporting various consumer associations, enabling a program provider to link different consumer associations;
a common database supporting various consumer associations, enabling a program provider to establish full or partial links between consumer associations, enabling additional benefits to members such as access to a wider range of participating merchants and/or special benefits available in one consumer association but not another;
a common database enabling a program provider to identify trends and marketing opportunities for members, merchants and the program provider, enabling targeted marketing appeals and increasingly efficient marketing efforts.

6. A customizable flexible repeatable affiliated consumer method that allows a program provider to enable a benefit such as a cash-back benefit calculated by reference to purchase amount to participating consumer members who give custom to participating merchants regardless of payment method.

7. A customizable flexible system enabling administration of the customizable flexible repeatable consumer association method, comprising:
an internet interface with program participants, enabling registration, information interchange, communication and transmission of instructions;
a database connected to a program participant interface, enabling collection and organization of data generated from program participants that can be manipulated and analyzed to administer consumer associations and enable implementation of the method;
software designed to implement the method, including establishment and integration of the database, program participant interface, communications, funds transfer, and collection and transmission of data and program materials (eg, invoices, instructions), to and from program participants.

8. A customizable flexible repeatable affiliated consumer method that allows a program provider to enable a benefit such as a cash-back benefit connected to special purpose savings accounts maintained by or on behalf of members by or on behalf of a program provider.
